(19) United States
(12) Patent Application Publication
(10) Pub. No.: US 2025/0294493 A1
(43) Pub. Date: Sep. 18, 2025

(54) PATH SWITCHING BETWEEN NON-3GPP ACCESS PATHS

(71) Applicant: Lenovo (Singapore) Pte. Ltd., Singapore (SG)

(72) Inventor: Apostolis Salkintzis, Athens (GR)

(21) Appl. No.: 18/861,094

(22) PCT Filed: Jun. 15, 2022
(86) PCT No.: PCT/EP2022/066332

§ 371 Date: Oct. 28, 2024

(30) Foreign Application Priority Data
Apr. 26, 2022 (GR) 20220100338

(51) Int. Cl. H04W 60/04; H04W 40/34; H04W 60/06; H04W 76/15

(52) U.S. Cl. CPC H04W 60/04; H04W 40/34; H04W 60/06; H04W 76/15

(57) ABSTRACT

Apparatuses, methods, and systems are disclosed for path switching between non-3GPP access paths. One apparatus includes a processor coupled to a transceiver, the processor configured to establish a multiaccess data connection using a first access network and a second access network, where the apparatus has a first registration with a communication network over the second access network. The processor sends a second registration request message that indicates a path switch of the multiaccess data connection from the second access network to the third access network. The processor switches traffic of the multiaccess data connection from the second access network to the third access network and deregisters the first registration in response to switching the traffic of the multiaccess data connection to the third access network.

### FIELD

The subject matter disclosed herein relates generally to wireless communications and more particularly relates to switching data traffic of a multiaccess protocol data unit (“MA PDU”) session between two non-3GPP access paths.

### BACKGROUND

Access Traffic Steering, Switching and Splitting (“ATSSS”) functionality enables the establishment of a multiaccess protocol data unit (“MA PDU”) session between a User Equipment (“UE”) and a User Plane Function (“UPF”), and policy-controlled routing of data traffic over different access networks.

### BRIEF SUMMARY

Disclosed are procedures for switching data traffic of a multiaccess protocol data unit (“MA PDU”) session between two non-3GPP access paths, where both access paths use the same Public Land Mobile Network (“PLMN”). Said procedures may be implemented by apparatus, systems, methods, or computer program products.

One method at a UE includes sending, to an access management function (“AMF”) in a mobile communication network, a first registration request message for a first registration over a second access network and establishing a multiaccess data connection using a first access network and the second access network, where the first access network has a first access type, and where the second access network and a third access network have a second access type. The method includes sending, to the access management function, a second registration request message for a second registration over the third access network, where the second registration request message indicates a path switch of the multiaccess data connection from the second access network to the third access network. The method includes switching traffic of the multiaccess data connection from the second access network to the third access network and deregistering the first registration over the second access network in response to switching the traffic of the multiaccess data connection to the third access network.

One method at an AMF includes receiving, from a UE, a first registration request message for a first registration with the mobile communication network over a second access network and determining that the UE has established a multiaccess data connection using a first access network and the second access network. The method includes receiving, from the UE, a second registration request message for a second registration over a third access network, where the second registration request message indicates a path switch of the multiaccess data connection from the second access network to the third access network, where the first access network has a first access type, and where the second access network and the third access network have a second access type. The method includes sending, to a session management function, a request to perform a path switch of the multiaccess data connection from the second access network to the third access network and deregistering the first registration in response to the path switch being complete.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for path switching between non-3GPP access paths;

FIG. 2A is a call-flow diagram illustrating one embodiment of a procedure for enabling data traffic switching between two non-3GPP access paths of a multiaccess Protocol Data Unit (“MA PDU”) Session;

FIG. 2B is a continuation of the call-flow diagram of FIG. 2A;

FIG. 3 is a diagram illustrating one embodiment of a multi-access data connection comprising multiple non-3GPP access paths via the same PLMN;

FIG. 4 is a block diagram illustrating one embodiment of a user equipment apparatus that may be used for path switching between non-3GPP access paths;

FIG. 5 is a block diagram illustrating one embodiment of a network apparatus that may be used for path switching between non-3GPP access paths; and

FIG. 6 is a flowchart diagram illustrating one embodiment of a method for path switching between non-3GPP access paths; and

FIG. 7 is a flowchart diagram illustrating another embodiment of a method for path switching between non-3GPP access paths.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for switching data traffic of a MA PDU session between two non-3GPP access paths. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

As already specified in Third-Generation Partnership Project (“3GPP”) specifications, a UE capable of supporting Access Traffic Steering, Switching, and/or Splitting (“ATSSS”), can simultaneously communicate with a 5G Core network (“5GC”) over a 3GPP access network (e.g., NG-RAN) and over a non-3GPP access network (e.g., WLAN). In such embodiments, the traffic exchanged between the UE and a Remote Host can either be distributed over both accesses (e.g., for bandwidth aggregation) or can be sent on the “best” access only, e.g., on the access characterized by the smallest latency, or the smallest Round-Trip Time (“RTT”). In the uplink (“UL”) direction, the UE decides how to distribute the traffic across the two accesses based on steering policy rules (called ATSSS rules) provided by the network. Similarly, in the downlink (“DL”) direction, the UPF at the edge of 5GC decides how to distribute the traffic across the two accesses based on corresponding steering policy rules (called N4 rules).

How the data traffic of the MA PDU session is routed across the two access networks is defined by a steering functionality and by a steering mode. Two steering functionalities have been defined in 3GPP Technical Specification (“TS”) 23.501: (a) the Multi-Path TCP (“MPTCP”) steering functionality and (b) the ATSSS-Low Layer (“ATSSS-LL”) steering functionality.

The ATSSS functionality enables the establishment of a MA PDU session between a UE and a UPF, and policy-controlled routing of data traffic over different access networks. Essentially, an MA PDU session is a multipath data connection between a UE and a UPF that can transfer data traffic using a first path over a first access network and a second path over a second access network. Current 3GPP specification consider scenarios where the first access network is a 3GPP access network (e.g., NR access or Evolved Universal Terrestrial Radio Access (“E-UTRA”)) and the second access network is a non-3GPP access network (e.g., Wi-Fi or wireline access).

However, there is a need to define how the data traffic of an MA PDU Session can be switched between one non-3GPP access path, e.g., from the UE to a N3IWF in a PLMN, and another non-3GPP access path, e.g., from the UE to a TNGF in the same PLMN. While the below solutions are described in the context of one access path via an N3IWF and another access path via a TNGF, the solutions described herein may also be applied to traffic switching between two non-3GPP access paths using two N3IWFs, or to traffic switching between two non-3GPP access paths using two TNGFs.

In various embodiments, the following assumptions apply to the below solutions for path switching between non-3GPP access paths:
Both non-3GPP access paths traverse the same PLMN.
One non-3GPP access path is using an N3IWF, while the other non-3GPP access path is using a TNGF.
After switching the traffic, only one UE registration via non-3GPP access may exist.
If the UE is able to access the same PLMN directly using 3GPP radio technology, then the UE may have an MA PDU Session with three access paths (two non-3GPP and one 3GPP) for the duration of switching the traffic from a source non-3GPP access path to a target non-3GPP access path.

The intention of the present disclosure is to specify procedures and related signaling to specify switching data traffic of a multiaccess protocol data unit (“MA PDU”) session between two non-3GPP access paths, where both non-3GPP access paths traverse the same PLMN.

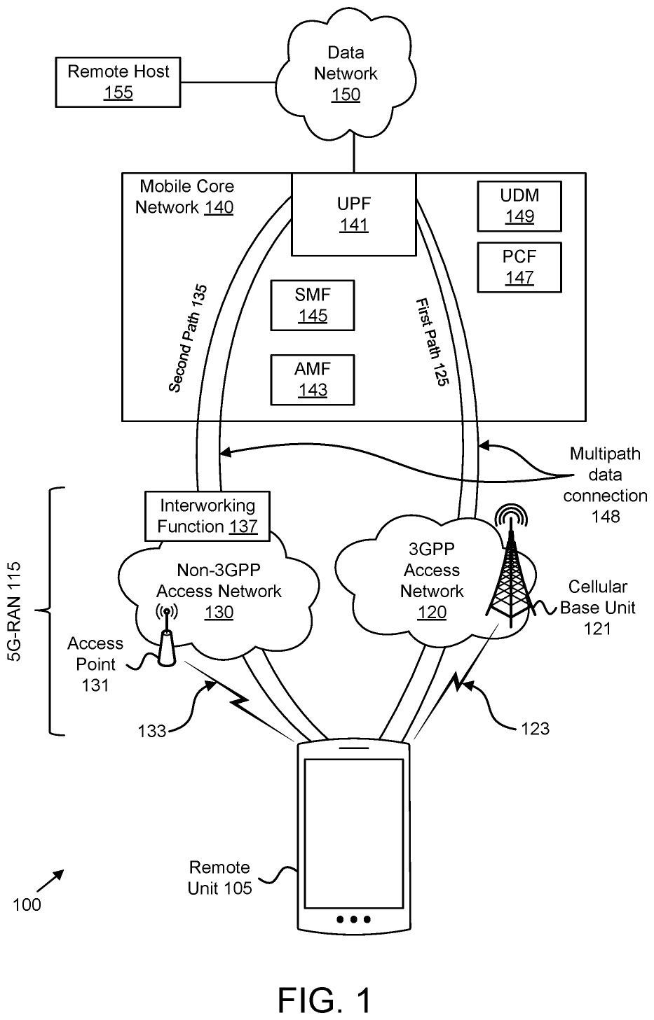

FIG. 1 depicts a wireless communication system 100 for path switching between non-3GPP access paths, according to embodiments of the disclosure. In one embodiment, the wireless communication system 100 includes at least one remote unit 105, a 5G Radio Access Network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit communicates with the 3GPP access network 120 using 3GPP communication links 123 and communicates with the non-3GPP access network 130 using non-3GPP communication links 133.

Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the 3GPP access network 120 is compliant with the Fifth-Generation (“5G”) system specified in the Third Generation Partnership Project (“3GPP”) specifications. In another implementation, the 3GPP access network 120 is compliant with the Long-Term Evolution (“LTE”) system specified in the 3GPP specifications. For example, the 3GPP access network 120 may comprise a New Generation Radio Access Network (“NG-RAN”), implementing New Radio (“NR”) Radio Access Technology (“RAT”) and/or LTE RAT. Moreover, the non-3GPP access network 130 may comprise a non-3GPP RAT (e.g., Wi-Fi® or Institute of Electrical and Electronics Engineers (“IEEE”) 802.11-family compliant WLAN).

More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like.

Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the cellular base units 121 in the 3GPP access network 120 via uplink (“UL”) and downlink (“DL”) communication signals. The UL and DL communication signals may be carried over the 3GPP communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host 155 (e.g., an application server) in the packet data network 150 via a network connection with the mobile core network 140. For example, an application (e.g., web browser, media client, telephone and/or Voice-over-Internet-Protocol (“VOIP”) application) in a remote unit 105 may trigger the remote unit 105 to establish a protocol data unit (“PDU”) session (or other data connection) with the mobile core network 140 via an access network in the 5G-RAN 115 (i.e., the 3GPP access network 120 and/or the non-3GPP access network 130). The mobile core network 140 then relays traffic between the remote unit 105 and the remote host 155 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

As used herein, Protocol Data Units (“PDUs”) refer to packets exchanged between peer entities in the same layer (e.g., of a protocol stack). In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW,” not shown) in the mobile core network 140. In certain embodiments, there is a one-to-one mapping between an EPS Bearer and a QoS profile, such that all packets belonging to a specific EPS Bearer have the same QoS Class Identifier (“QCI”).

Moreover, the remote unit 105 may establish a multiaccess PDU session (i.e., multiaccess data connection) with the mobile core network 140. Each multiaccess data connection is composed of one or more paths, each path using a different access network. For example, the multiaccess data connection 148 is composed of a first path 125, using a 3GPP access network 120, and a second path 135, using a non-3GPP access network 130. In addition, the remote unit 105 may establish more than one access path using a non-3GPP access network. Traffic sent via the multiaccess data connection 148 is steered over one or both of the paths 125, 135, according to steering rules. Note that the first and second access paths 125, 135 support one or more multipath data connections 148 and have a common anchor in the UPF 141.

The remote unit 105 may be configured with a steering policy and QoS policy, which is applied to direct traffic to one of paths of the multiaccess PDU session. Additionally, Access Traffic Steering, Switching and Splitting (“ATSSS”) functionality is implemented in the remote unit 105 and UPF 141 to support data traffic transmission using, e.g., policy-based steering of the data traffic across the different access networks (such as the non-3GPP access network 130 and the 3GPP access network 120).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the 3GPP access network 120, that may include one or more controllers communicably coupled to one or more corresponding base units 121. These and other elements of radio access network are not illustrated but are well known generally by those having ordinary skill in the art. The base units 121 connect to the mobile core network 140 via the 3GPP access network 120.

The base units 121 may serve a number of remote units 105 within a serving area, for example, a cell or a cell sector, via a 3GPP communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking function 137. The interworking function 137 provides interworking between the remote unit 105 and the mobile core network 140. The interworking function 137 supports connectivity to the mobile core network 140 via the “N2” and “N3” interfaces, and it relays “N1” signaling between the remote unit 105 and the AMF 143. Both the 3GPP access network 120 and the interworking function 137 communicate with the AMF 143 using a “N2” interface. The interworking function 137 also communicates with the UPF 141 using a “N3” interface.

In some embodiments, the interworking function 137 is a Non-3GPP Interworking Function (“N3IWF”) and, in other embodiments, it is a Trusted Non-3GPP Gateway Function (“TNGF”). In one embodiment, the second path 135 (i.e., non-3GPP access path) uses a N3IWF. In another embodiment, the second path 135 (i.e., non-3GPP access path) may use a TNGF. As described in greater detail below, the ATSSS functionality may switch from a first non-3GPP access path that uses a N3IWF to a second non-3GPP access path that uses a TNGF, or vice versa.

The N3IWF supports the connection of “untrusted” non-3GPP access networks to the mobile core network (e.g., 5GC), whereas the TNGF supports the connection of “trusted” non-3GPP access networks to the mobile core network. In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the 5G-RAN 115, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server. In some embodiments, the mobile core network 140 may include a Performance Measurement Functionality (“PMF”) (not shown) to assist the remote unit 105 and/or the UPF 141 in taking performance measurements over the two accesses, including latency measurements. In one embodiment, the PMF may be co-located with the UPF 141.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for path switching between non-3GPP access paths apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “gNB” is used for the base station/base unit, but it is replaceable by any other radio access node, e.g., RAN node, ng-eNB, eNB, Base Station (“BS”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for path switching between non-3GPP access paths.

In various embodiments, the remote unit 105 (i.e., UE) communicates with a Remote Host 155 via a multiaccess PDU Session, whereby multiple access paths are established over a non-3GPP access network 130. The remote unit 105 directs uplink traffic over one or more paths according to a steering policy. New ATSSS functionality is implemented in the UE and UPF for switching data traffic of a MA PDU session between two non-3GPP access paths, as described in greater detail below.

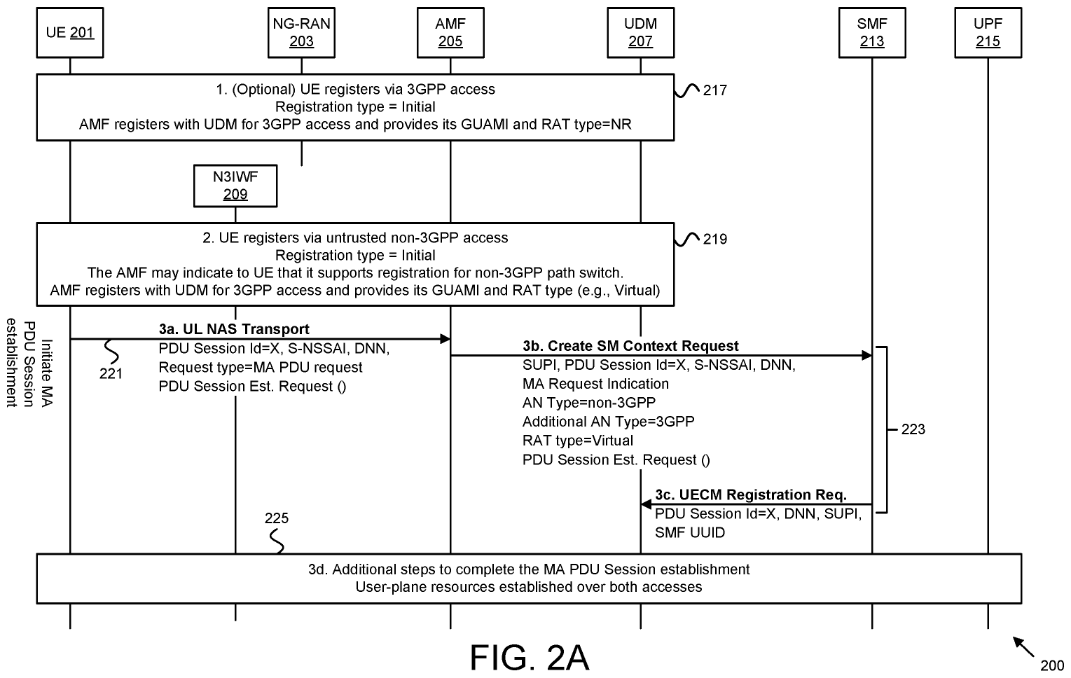

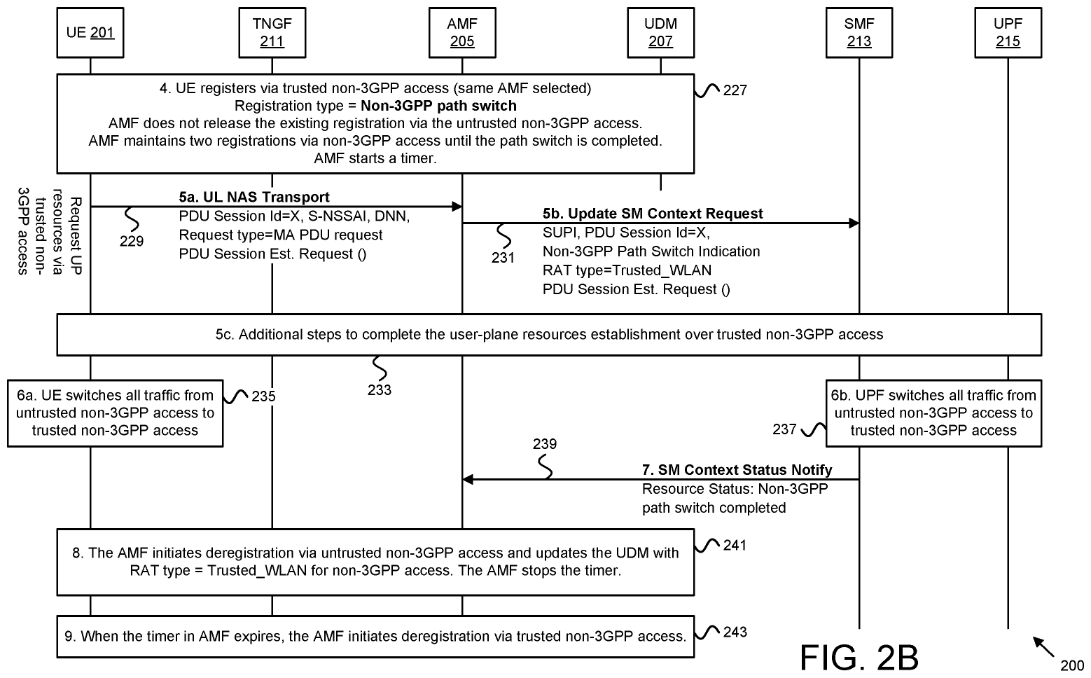

FIGS. 2A-2B depict a procedure 200 for enabling the data traffic of an MA PDU Session to be switched from a non-3GPP access path using a N3IWF to a non-3GPP access path using a TNGF, according to embodiments of the disclosure. The same steps can be used to switch the data traffic of an MA PDU Session between any non-3GPP access paths (using either N3IWF or TNGF). The procedure 200 involves the UE 201 (e.g., an embodiment of the remote unit 105), the NG-RAN 203 (e.g., an embodiment of the 3GPP access network 120), an AMF 205 (e.g., an embodiment of the AMF 143), a UDM 207 (e.g., an embodiment of the UDM/UDR 149), a N3IWF 209 (e.g., one embodiment of the interworking function 137), a TNGF 211 (e.g., another embodiment of the interworking function 137), an SMF 213 (e.g., one embodiment of the SMF 145), and a UPF 215 (e.g., one embodiment of the UPF 141). Here, the AMF 205, the UDM 207 and the SMF 209 are network functions in a 5GC. It is assumed that the AMF 205, the UDM 207, the SMF 209, and the UPF 215 are part of the same PLMN.

Starting on FIG. 2A, the procedure 200 begins at Step 1 when the UE 201 optionally performs an initial registration with a PLMN via a 3GPP access network (i.e., the NG-RAN 203) (see block 217). During the initial registration procedure, the UE 201 selects an AMF (here, the AMF 205) and the selected AMF 205 registers with the UDM 207 for 3GPP access. In various embodiments, the AMF 205 provides its identity and RAT type that indicates a 3GPP access (e.g., RAT type=‘NR’). Note that the AMF identity may be a Globally Unique AMF ID (“GUAMI”), i.e., comprising the PLMN identifier (i.e., MCC (Mobile Country Code) and MNC (Mobile Network Code)), an AMF Region ID, an AMF Set ID, and an AMF Pointer.

At Step 2, the UE 201 selects an N3IWF (here, the N3IWF 209) and performs an initial 5G registration over untrusted non-3GPP access in the same PLMN (see block 219). Here, the same AMF 205 is selected, as in the previous step. Again, the AMF 205 registers with the UDM 207 for non-3GPP access and provides its identifier (e.g., GUAMI). Note here that the AMF 205 provides a RAT type that indicates a non-3GPP access (e.g., RAT type=‘Virtual’ or ‘WLAN’). In certain embodiments, the AMF 205 may indicate to UE 201 whether it supports registration for non-3GPP path switching (see further below).

At Step 3, the UE 201 requests an MA PDU Session, e.g., as specified in 3GPP TS 23.402, clause 4.22.2, which section is hereby incorporated by reference (see messaging 221). User-plane resource are established over 3GPP access and over untrusted non-3GPP access (see messaging 223). Upon completing the MA PDU Session establishment, data traffic over the MA PDU Session is exchanged between the UE and UPF 215 using the two accesses (see block 225).

Continuing on FIG. 2B, at Step 4, the UE 201 detects a trusted non-3GPP access network that supports 5G connectivity to the same PLMN. The UE 201 decides to switch the data traffic transferred over the untrusted non-3GPP access of the MA PDU Session to the detected trusted non-3GPP access network. For this purpose, the UE 201 initiates a 5G registration over trusted non-3GPP access and indicates a non-3GPP path switch, e.g., by setting the registration 20) type to “Non-3GPP path switch” (see block 227).

The “Non-3GPP path switch” registration type indicates that the registration over trusted non-3GPP access is needed for switching the data traffic of an MA PDU Session to a new non-3GPP path. If the AMF 205 does not support this registration type, then the AMF 205 rejects this request. For example, if the AMF 205 indicates to the UE 201 whether it supports registration for non-3GPP path switch, e.g., in Step 2, then the UE 201 initiates a 5G registration over trusted non-3GPP access with registration type to “Non-3GPP patch switch” only when the AMF 205 supports this registration type. In an alternative embodiment, the UE 201 may indicate the non-3GPP path switch using a separate indication that is separate from the registration type field.

In the depicted embodiments, the UE 201 implicitly requests a non-3GPP path switch by initiating a second 5G registration with a non-3GPP access type but does not explicitly indicate the untrusted non-3GPP access network or the initial 5G registration over untrusted non-3GPP access performed in Step 2. The AMF 205 determines that, since the access type of the trusted non-3GPP access network is “non-3GPP”, then the non-3GPP access of the multiaccess data connection (i.e., the untrusted non-3GPP access network) must be substituted with the trusted non-3GPP access network. However, in other embodiments the UE 201 explicitly request the non-3GPP path switch, e.g., by including a specific parameter in the registration request message.

After the UE 201 is registered via trusted non-3GPP access (i.e., corresponding to TNGF 211), e.g., with registration type “Non-3GPP patch switch”, the AMF 205 does not release the exiting registration via untrusted non-3GPP access (i.e., corresponding to N3IWF 209). Rather, the AMF 205 starts a timer and maintains the two registrations via non-3GPP access until the path switch is completed or until this timer expires. As discussed below (see Step 9), when the timer expires, the AMF 205 initiates deregistration via the TNGF 211.

At Step 5, the UE 201 initiates the non-3GPP path switch by requesting user-plane resources via trusted non-3GPP access. To request these user-plane resources, the UE 201 may send a PDU Session Establishment Request via the TNGF 211, which contains request type=“MA PDU Request” and the identity of the existing MA PDU Session (see messaging 229).

The AMF 205 sends an Update Session Management (“SM”) Context Request to the SMF 213, which contains a “Non-3GPP path switch indication” (see messaging 231). This indication informs the SMF 213 that the PDU Session Establishment Request is sent to enable path switching from the existing non-3GPP access of the MA PDU Session to a new non-3GPP access. The AMF 205 inserts the “Non-3GPP path switch indication” in the Update SM Context Request because the UE 201 is registered with type “Non-3GPP path switch” (see Step 4).

The SMF 213 initiates the user-plane resources establishment over trusted non-3GPP access (see block 233).

At Step 6, after user-plane resources are established over trusted non-3GPP access, the UE 201 switches all uplink MA PDU Session traffic from untrusted non-3GPP access to trusted non-3GPP access (see block 235). Similarly, the UPF 215 switches all downlink MA PDU Session traffic from untrusted non-3GPP access to trusted non-3GPP access, e.g., as the SMF 213 modifies the existing N4 connection (see block 237).

At Step 7, the SMF 213 sends an SM Context Status Notify message to AMF 205 to indicate that the non-3GPP path switch has been completed (see messaging 239). Here, the SM Context Status Notify message indicates that switch over to the trusted non-3GPP access was successful.

At Step 8, after receiving the SM Context Status Notify message, the AMF 205 deregisters the UE 201 via the untrusted non-3GPP access (i.e., corresponding to N3IWF 209) and updates the UDM 207 with parameter RAT type=“Trusted_WLAN” for non-3GPP access (see block 241). Additionally, the AMF 205 stops the timer that was started in Step 4. After Step 8, the UE 201 has only one 5G registration via non-3GPP access (i.e., the registration initiated in Step 4).

However, at Step 9, upon expiry of the AMF timer started in Step 4, the AMF 205 deregisters the UE 201 via the trusted non-3GPP access (i.e., corresponding to TNGF 211) (see block 243). Here, expiry of the timer indicates that switch over to the trusted non-3GPP access was unsuccessful. After Step 9, the UE has only one 5G registration via non-3GPP access (i.e., the registration initiated in Step 2).

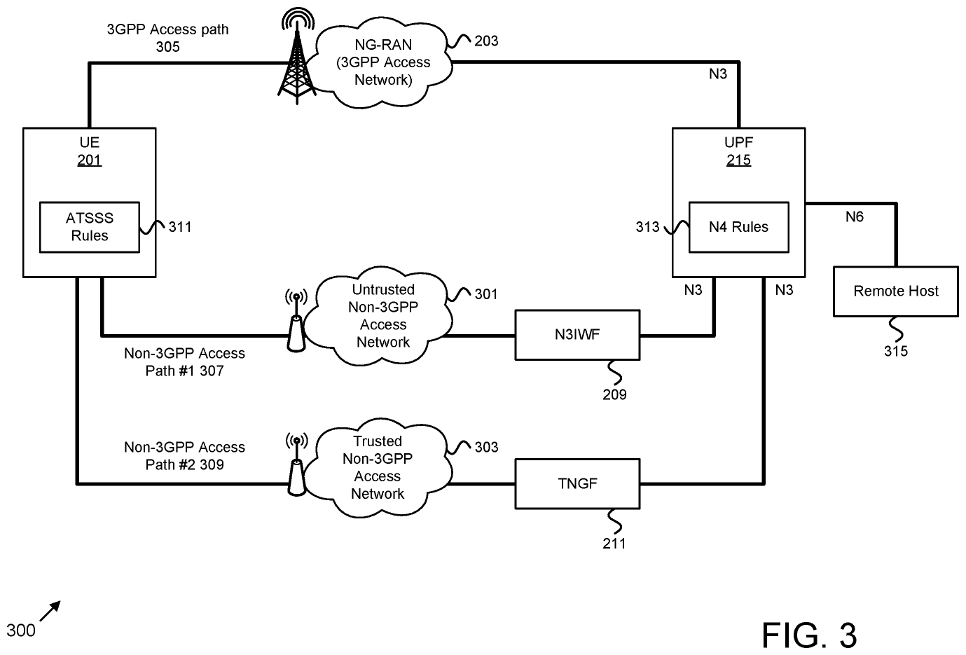

FIG. 3 depicts an example of a network architecture 300 supporting a multiaccess data connection having an external access path over a different PLMN, according to embodiments of the disclosure. The network architecture 300 includes the UE 201, the NG-RAN 203, an untrusted non-3GPP access network 301, the N3IWF 209, a trusted non-3GPP access network 303, the TNGF 211, and the UPF 215.

As depicted, the multi-access data connection comprises a first access path (denoted as “3GPP Access Path”) 305 over the NG-RAN 203, a second access path (denoted as “Non-3GPP Access Path #1”) 307 over the untrusted non-3GPP access network 301 and using the N3IWF 209, and a third access path (denoted as “Non-3GPP Access Path #2) 309 over a the trusted non-3GPP access network 303 and using the TNGF 211. The UE 201 communicates with the remote host 315 via one or more of the 3GPP Access Path 305, the Non-3GPP Access Path #1 307, and the Non-3GPP Access Path #2 309.

As discussed above, the UE 201 is configured with ATSSS rules 311 for routing UL traffic over one or more of the 3GPP Access Path 305, the Non-3GPP Access Path #1 307, and the Non-3GPP Access Path #2 309. Similarly, the UPF 215 may be configured with N4 rules 313 for routing DL traffic over one or more of the 3GPP Access Path 305, the Non-3GPP Access Path #1 307, and the Non-3GPP Access Path #2 309.

Note that after Step 5 of the procedure 200, the UE 201 has up to three active paths in the multiaccess data connection (i.e., a MA PDU), i.e., the Non-3GPP Access Path #1 307, and the Non-3GPP Access Path #2 309, and-optionally-the 3GPP Access Path 305.

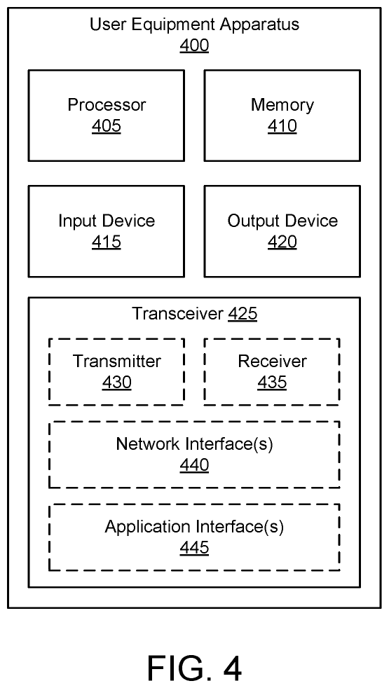

FIG. 4 depicts one embodiment of a user equipment apparatus 400 that may be used for path switching between non-3GPP access paths, according to embodiments of the disclosure. The user equipment apparatus 400 may be one embodiment of the remote unit 105 and/or the UE 201. Furthermore, the user equipment apparatus 400 may include a processor 405, a memory 410, an input device 415, an output device 420, a transceiver 425.

In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 425 and at least one receiver 435. In some embodiments, the transceiver 425 communicates with one or more cells (or wireless coverage areas) supported by one or more base units 121 and/or access points 131. In various embodiments, the transceiver 425 is operable on unlicensed spectrum. Moreover, the transceiver 425 may include multiple UE panels supporting one or more beams. Additionally, the transceiver 425 may support at least one network interface 440 and/or application interface 445.

The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425.

In various embodiments, the transceiver 425 is configured to communicate with a mobile communication network over one or more of: a first access network (e.g., a NG-RAN), a second access network (e.g., untrusted WLAN), and a third access network (e.g., trusted WLAN), where the first access network has a first access type (e.g., 3GPP access) and the second access network and the third access network have a second access type (e.g., non-3GPP access). Via the transceiver 425, the processor 405 sends a first registration request message to an access management function in the mobile communication network, the first registration request message initiating a first registration over the second access network. The processor 405 establishes a multiaccess data connection using the first access network and the second access network.

Via the transceiver 425, the processor 405 sends a second registration request message to the access management function, the second message initiating a second registration over the third access network. Here, the second registration request message indicates a path switch of the multiaccess data connection from the second access network to the third access network. In one embodiment, the second registration request message implicitly requests the path switch to the third access network by including a specific access type parameter in the second registration request (e.g., indicating the second access type). In another embodiment, the second registration request includes a parameter that requests the path switch to the third access network.

The processor 405 switches traffic of the multiaccess data connection from the second access network to the third access network and deregisters the first registration over the second access network in response to switching the traffic of the multiaccess data connection to the third access network. In some embodiments, to switch the traffic of the multiaccess data connection, the processor 405 sends a request to establish a data connection via the third access network. In certain embodiments, the request to establish a data connection via the third access network includes a non-3GPP path switch indication.

In some embodiments, the first registration request message has a registration type set to an initial registration type, and the second registration request message has a registration type set to a path switch registration type. In certain embodiments, the transceiver 425 receives a first registration response message from the access management function, the first registration response message indicating that the access management function supports the path switch registration type. In some embodiments, the second access network is an untrusted non-3GPP access network, and the third access network is a trusted non-3GPP access network.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to establishing a multipath unicast link and/or mobile operation. For example, the memory 410 may store various parameters, panel/beam configurations, resource assignments, policies, and the like as described above. In certain embodiments, the memory 410 also stores program code and related data, such as an operating system or other controller algorithms operating on the user equipment apparatus 400.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, the output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least transmitter 430 and at least one receiver 435. One or more transmitters 425 may be used to provide UL communication signals to a cellular base unit 121 and/or an access point 131, such as the UL transmissions described herein. Similarly, one or more receivers 435 may be used to receive DL communication signals from the cellular base unit 121 and/or an access point 131, as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

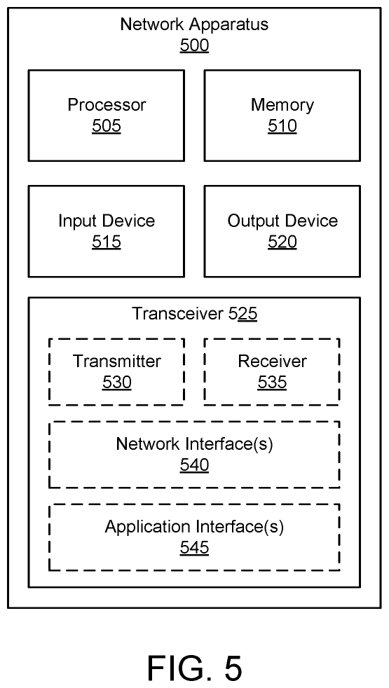

FIG. 5 depicts one embodiment of a network apparatus 500 that may be used for path switching between non-3GPP access paths, according to embodiments of the disclosure. In some embodiments, the network apparatus 500 may implement an AMF and/or a UPF. In further embodiments, the network apparatus 500 may implement an interworking function, such as the N3IWF and/or TNGF. Furthermore, network apparatus 500 may include a processor 505, a memory 510, an input device 515, an output device 520, a transceiver 525.

In some embodiments, the input device 515 and the output device 520 are combined into a single device, such as a touchscreen. In certain embodiments, the network apparatus 500 may not include any input device 515 and/or output device 520. In various embodiments, the network apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a CPU, a GPU, an auxiliary processing unit, a FPGA, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the network apparatus 500 is a RAN node (e.g., gNB) that communicates with one or more UEs, as described herein. In such embodiments, the processor 505 controls the network apparatus 500 to perform the above described RAN behaviors. When operating as a RAN node, the processor 505 may include an application processor (also known as “main processor”) which manages application-domain and operating system (“OS”) functions and a baseband processor (also known as “baseband radio processor”) which manages radio functions.

In various embodiments, the network apparatus 500 includes an AMF that communicates with one or more entities in a mobile communication network (e.g., via a transceiver 525 and/or network interface 540), as described herein. In such embodiments, the processor 505 controls the network apparatus 500 to perform the above described AMF entity behaviors.

In various embodiments, the transceiver 525 is configured to communicate with a UE over one or more of: a first access network (e.g., a NG-RAN), a second access network (e.g., an untrusted WLAN), and a third access network (e.g., trusted WLAN). Note that the processor 505 and transceiver 525 may communicate with the UE via a network interface 540, such as the N1 interface as defined by 3GPP. Via the transceiver 525, the processor 505 receives a first registration request message from the UE, the first registration message initiating a first registration with the mobile communication network over the second access network. The processor 505 determines that the UE has established a multiaccess data connection using the first access network and the second access network.

Via the transceiver 525, the processor 505 receives a second registration request message from the UE, the second registration request initiating a second registration over the third access network. In various embodiments, the second registration request message indicates a path switch of the multiaccess data connection from the second access network to the third access network, where the first access network has a first access type (e.g., 3GPP) and the second access network and a third access network have a second access type (e.g., non-3GPP). In one embodiment, the second registration request message implicitly requests the path switch to the third access network by including a specific access type parameter in the second registration request (e.g., indicating the second access type). In another embodiment, the second registration request includes a parameter that requests the path switch to the third access network.

The processor 505 sends, to a SMF (i.e., via the transceiver 525), a request to perform a path switch of the multiaccess data connection from the second access network to the third access network and deregisters the first registration in response to the path switch being complete. In some embodiments, the request to perform a path switch of the multiaccess data connection from the second access network to the third access network comprises request to update a session management context, the request to update a session management context comprising a non-3GPP path switch indication.

In some embodiments, the processor 505 receives, from the SMF (i.e., via the transceiver 525), a notification that the path switch is complete. In such embodiments, the processor 505 deregisters the first registration occurs after receiving the notification. In some embodiments, the second access network is an untrusted non-3GPP access network, and the third access network is a trusted non-3GPP access network.

In some embodiments, the processor 505 initiates a timer in response to receiving the second registration request message that indicates the path switch of the multiaccess data connection. In such embodiments, the apparatus 500 maintains both the first registration and the second registration until the path switch is complete or the timer expires. In certain embodiments, the processor 505 is further configured to cause the second apparatus to stop the timer in response to receiving a notification (e.g., from the SMF) that the path switch is complete.

In some embodiments, the first registration request message has a registration type set to an initial registration type and the second registration request message has a registration type set to a path switch registration type. In certain embodiments, the processor 505 further sends a first registration response message to the UE (i.e., via the transceiver 525), where the first registration response message indicates that the second apparatus supports the path switch registration type.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to establishing a multipath unicast link and/or mobile operation. For example, the memory 510 may store parameters, configurations, resource assignments, policies, and the like, as described above. In certain embodiments, the memory 510 also stores program code and related data, such as an operating system or other controller algorithms operating on the network apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

The transceiver 525 includes at least transmitter 530 and at least one receiver 535. One or more transmitters 525 may be used to communicate with the UE, as described herein. Similarly, one or more receivers 535 may be used to communicate with network functions in the PLMN and/or RAN, as described herein. Although only one transmitter 530 and one receiver 535 are illustrated, the network apparatus 500 may have any suitable number of transmitters 530 and receivers 535. Further, the transmitter(s) 530 and the receiver(s) 535 may be any suitable type of transmitters and receivers.

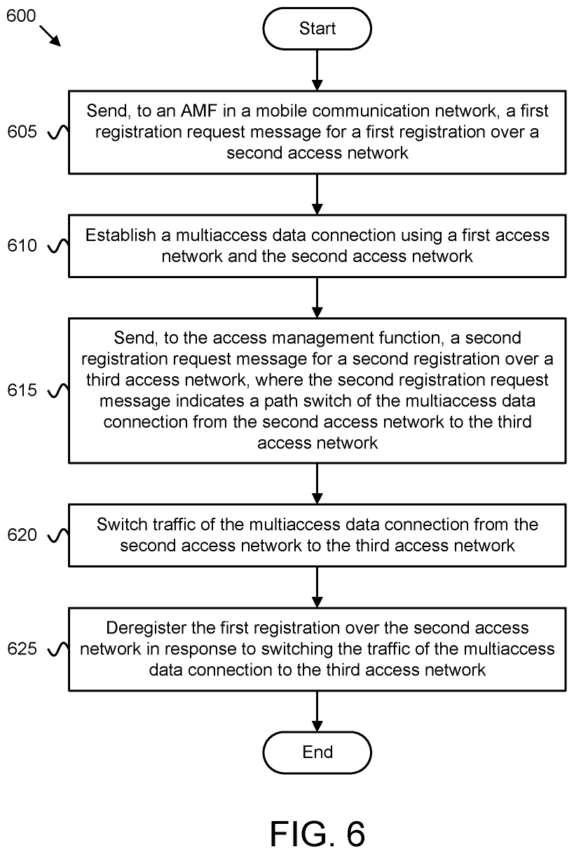

FIG. 6 depicts one embodiment of a method 600 for path switching between non-3GPP access paths, according to embodiments of the disclosure. In various embodiments, the method 600 is performed by a UE device, such as the remote unit 105, the UE 201, and/or the user equipment apparatus 500, described above as described above. In some embodiments, the method 600 is performed by a processor, such as a microcontroller, a microprocessor, a CPU, a GPU, an auxiliary processing unit, a FPGA, or the like.

The method 600 begins and sends 605, to an AMF in a mobile communication network, a first registration request message for a first registration over a second access network (e.g., an untrusted WLAN). The method 600 includes establishing 610 a multiaccess data connection using a first access network (e.g., NG-RAN) and the second access network. The method 600 includes sending 615, to the access management function, a second registration request message for a second registration over the third access network (e.g., a trusted WLAN), where the second registration request message indicates a path switch of the multiaccess data connection from the second access network to the third access network. The method 600 includes switching 620 traffic of the multiaccess data connection from the second access network to the third access network. The method 600 includes deregistering 625 the first registration over the second access network in response to switching the traffic of the multiaccess data connection to the third access network. The method 600 ends.

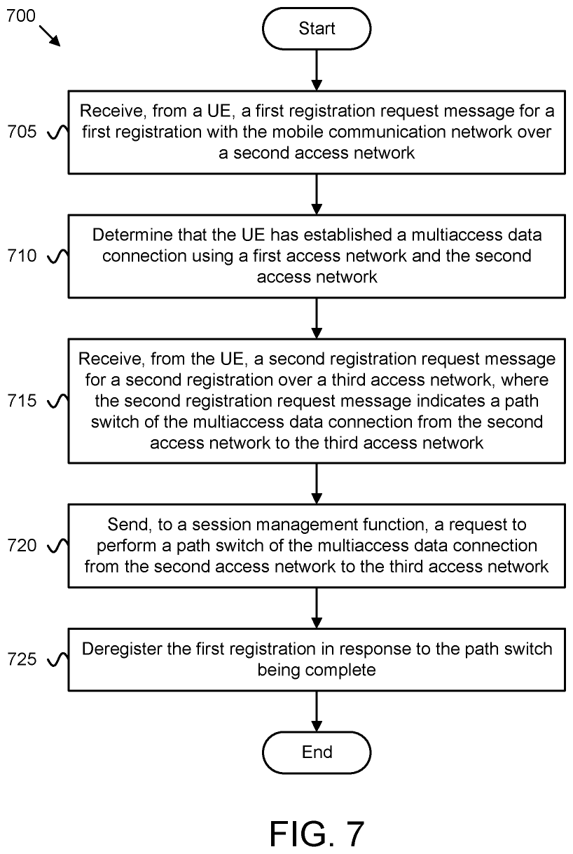

FIG. 7 depicts one embodiment of a method 700 for path switching between non-3GPP access paths, according to embodiments of the disclosure. In various embodiments, the method 700 is performed by a network function in a mobile communication network, such as the AMF 143, the AMF 205, and/or the network apparatus 500, described above as described above. In some embodiments, the method 700 is performed by a processor, such as a microcontroller, a microprocessor, a CPU, a GPU, an auxiliary processing unit, a FPGA, or the like.

The method 700 begins and receives 705, from a UE, a first registration request message for a first registration with the mobile communication network over a second access network. The method 700 includes determining 710 that the UE has established a multiaccess data connection using a first access network and the second access network. The method 700 includes receiving 715, from the UE, a second registration request message for a second registration over a third access network, where the second registration request message indicates a path switch of the multiaccess data connection from the second access network to the third access network. The method 700 includes sending 720, to a session management function, a request to perform a path switch of the multiaccess data connection from the second access network to the third access network. The method 700 includes deregistering 725 the first registration in response to the path switch being complete. The method 700 ends.

Disclosed herein is a first apparatus for path switching between non-3GPP access paths, according to embodiments of the disclosure. The first apparatus may be implemented by a UE device, such as the remote unit 105, the UE 201, and/or the user equipment apparatus 500, described above. The first apparatus includes a transceiver configured to communicate with a mobile communication network over one or more of: a first access network (e.g., a NG-RAN), a second access network (e.g., untrusted WLAN), and a third access network (e.g., trusted WLAN). In one embodiment, the first access network has a first access type (e.g., 3GPP) and the second access network and a third access network have a second access type (e.g., non-3GPP). The first apparatus further includes a processor coupled to the transceiver, the processor configured to cause the apparatus to send, to an access management function in the mobile communication network, a first registration request message for a first registration over the second access network and to establish a multiaccess data connection using the first access network and the second access network.

The processor is configured to cause the apparatus to send, to the access management function, a second registration request message for a second registration over the third access network, where the second registration request message indicates a path switch of the multiaccess data connection from the second access network to the third access network. The processor is configured to cause the apparatus to switch traffic of the multiaccess data connection from the second access network to the third access network and to deregister the first registration over the second access network in response to switching the traffic of the multiaccess data connection to the third access network.

In some embodiments, the first registration request message has a registration type set to an initial registration type, and the second registration request message has a registration type set to a path switch registration type. In certain embodiments, the processor is further configured to cause the apparatus to receive a first registration response message from the access management function, the first registration response message indicating that the access management function supports the path switch registration type.

In some embodiments, to switch the traffic of the multiaccess data connection, the processor is configured to cause the apparatus to request to establish a data connection via the third access network. In certain embodiments, the request to establish a data connection via the third access network includes a non-3GPP path switch indication. In some embodiments, the second access network is an untrusted non-3GPP access network, and the third access network is a trusted non-3GPP access network.

Disclosed herein is a first method for path switching between non-3GPP access paths, according to embodiments of the disclosure. The first method may be performed by a UE device entity, such as the remote unit 105, the UE 201, and/or the user equipment apparatus 400, described above. The first method includes sending, to an access management function in a mobile communication network, a first registration request message for a first registration over a second access network (e.g., an untrusted WLAN) and establishing a multiaccess data connection using a first access network (e.g., NG-RAN) and the second access network. In one embodiment, the first access network has a first access type (e.g., 3GPP) and the second access network has a second access type (e.g., non-3GPP).

The first method includes sending, to the access management function, a second registration request message for a second registration over a third access network (e.g., a trusted WLAN), where the second registration request message indicates a path switch of the multiaccess data connection from the second access network to the third access network, where the second access network and the third access network have the same access type (e.g., non-3GPP type). The first method includes switching traffic of the multiaccess data connection from the second access network to the third access network and deregistering the first registration over the second access network in response to switching the traffic of the multiaccess data connection to the third access network.

In some embodiments, the first registration request message has a registration type set to an initial registration type, and the second registration request message has a registration type set to a path switch registration type. In certain embodiments, the first method includes receiving a first registration response message from the access management function, the first registration response message indicating that the access management function supports the path switch registration type.

In some embodiments, switching the traffic of the multiaccess data connection includes sending a request to establish a data connection via the third access network. In certain embodiments, the request to establish a data connection via the third access network includes a non-3GPP path switch indication. In some embodiments, the second access network is an untrusted non-3GPP access network, and the third access network is a trusted non-3GPP access network.

Disclosed herein is a second apparatus for path switching between non-3GPP access paths, according to embodiments of the disclosure. The second apparatus may be implemented by a network function, such as the AMF 143, the AMF 205, and/or the network apparatus 500, described above. The second apparatus includes a transceiver configured to communicate with a UE over one or more of: a first access network (e.g., a NG-RAN), a second access network (e.g., an untrusted WLAN), and a third access network (e.g., trusted WLAN). In one embodiment, the first access network has a first access type (e.g., 3GPP) and the second access network and a third access network have a second access type (e.g., non-3GPP). The second apparatus includes a processor coupled to the transceiver, the processor configured to cause the second apparatus to receive, from the UE, a first registration request message for a first registration with the mobile communication network over the second access network and to determine that the UE has established a multiaccess data connection using the first access network and the second access network.

The processor is configured to cause the second apparatus to receive, from the UE, a second registration request message for a second registration over the third access network, where the second registration request message indicates a path switch of the multiaccess data connection from the second access network to the third access network. The processor is configured to send, to a session management function, a request to perform a path switch of the multiaccess data connection from the second access network to the third access network and to deregister the first registration in response to the path switch being complete.

In some embodiments, the request to perform a path switch of the multiaccess data connection from the second access network to the third access network comprises request to update a session management context, the request to update a session management context comprising a non-3GPP path switch indication. In some embodiments, the processor is further configured to receive, from the session management function, a notification that the path switch is complete. In such embodiments, deregistering the first registration occurs after receiving the notification.

In some embodiments, the processor is further configured to cause the second apparatus to initiate a timer in response to receiving the second registration request message that indicates the path switch of the multiaccess data connection. In such embodiments, the second apparatus maintains both the first registration and the second registration until the path switch is complete or the timer expires. In certain embodiments, the processor is further configured to cause the second apparatus to stop the timer in response to receiving a notification that the path switch is complete.

In some embodiments, the first registration request message has a registration type set to an initial registration type and the second registration request message has a registration type set to a path switch registration type. In certain embodiments, the processor is further configured to cause the second apparatus to send a first registration response message to the UE, the first registration response message indicating that the second apparatus supports the path switch registration type. In some embodiments, the second access network is an untrusted non-3GPP access network, and the third access network is a trusted non-3GPP access network.

Disclosed herein is a second method for path switching between non-3GPP access paths, according to embodiments of the disclosure. The second method may be performed by a network function, such as the AMF 143, the AMF 205, and/or the network apparatus 500, described above. The second method includes receiving, from a UE, a first registration request message for a first registration with the mobile communication network over a second access network and determining that the UE has established a multiaccess data connection using a first access network and the second access network. In one embodiment, the first access network has a first access type (e.g., 3GPP type) and the second access network has a second access type (e.g., non-3GPP type).

The second method includes receiving, from the UE, a second registration request message for a second registration over a third access network, where the second registration request message indicates a path switch of the multiaccess data connection from the second access network to the third access network, where the second access network and the third access network have the same access type (e.g., non-3GPP type). The second method includes sending, to a session management function, a request to perform a path switch of the multiaccess data connection from the second access network to the third access network and deregistering the first registration in response to the path switch being complete.

In some embodiments, the request to perform a path switch of the multiaccess data connection from the second access network to the third access network comprises request to update a session management context, the request to update a session management context comprising a non-3GPP path switch indication. In some embodiments, the processor is further configured to receive, from the session management function, a notification that the path switch is complete. In such embodiments, deregistering the first registration occurs after receiving the notification.

In some embodiments, the processor is further configured to cause the network apparatus to initiate a timer in response to receiving the second registration request message that indicates the path switch of the multiaccess data connection. In such embodiments, the network apparatus maintains both the first registration and the second registration until the path switch is complete or the timer expires. In certain embodiments, the processor is further configured to cause the network apparatus to stop the timer in response to receiving a notification that the path switch is complete.

In some embodiments, the first registration request message has a registration type set to an initial registration type, and the second registration request message has a registration type set to a path switch registration type. In certain embodiments, the processor is further configured to cause the network apparatus to send a first registration response message to the UE, the first registration response message indicating that the network apparatus supports the path switch registration type. In some embodiments, the second access network is an untrusted non-3GPP access network, and the third access network is a trusted non-3GPP access network.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transceiver configured to communicate with a mobile communication network over one or more of: a first access network, a second access network, and a third access network; and
at least one memory; and
at least one processor coupled with the at least one memory and configured to cause the UE to:
transmit, to an access and mobility management function (AMF), a first registration request message for a first registration over a second access network;
establish a multiaccess data connection using a first access network and the second access network;
transmit, to the AMF, a second registration request message for a second registration over a third access network, wherein the second registration request message indicates a path switch of the multiaccess data connection from the second access network to the third access network;
switch traffic of the multiaccess data connection from the second access network to the third access network; and
deregister the first registration over the second access network in response to switching the traffic of the multiaccess data connection to the third access network.

2. The UE of claim 1, wherein the first registration request message has a registration type set to an initial registration type, and wherein the second registration request message has a registration type set to a path switch registration type.

3. The UE of claim 2, wherein the at least one processor is further configured to cause the UE to receive a first registration response message from the AMF, the first registration response message indicating that the AMF supports the path switch registration type.

4. The UE of claim 1, wherein, to switch the traffic of the multiaccess data connection, the at least one processor is configured to cause the UE to transmit a request to establish a data connection via the third access network.

5. The UE of claim 4, wherein the request to establish the data connection via the third access network comprises a non-3GPP path switch indication.

6. The UE of claim 1, wherein the second access network is an untrusted non-3GPP access network and wherein the third access network is a trusted non-3GPP access network.

7. A processor for wireless communication, comprising:
at least one controller coupled with at least one memory and configured to cause the processor to:
transmit, to an access and mobility management function (AMF), a first registration request message for a first registration over a second access network;
establish a multiaccess data connection using a first access network and the second access network;
transmit, to the AMF, a second registration request message for a second registration over a third access network, wherein the second registration request message indicates a path switch of the multiaccess data connection from the second access network to the third access network;
switch traffic of the multiaccess data connection from the second access network to the third access network; and
deregister the first registration over the second access network in response to switching the traffic of the multiaccess data connection to the third access network.

8. A network apparatus supporting an access and mobility management function (AMF), the network apparatus comprising:
at least one memory; and
at least one processor coupled with the at least one memory and configured to cause the network apparatus to:
receive, from a user equipment (UE), a first registration request message for a first registration with the mobile communication network over a second access network;
determine that the UE has established a multiaccess data connection using a first access network and the second access network;
receive, from the UE, a second registration request message for a second registration over a third access network, wherein the second registration request message indicates a path switch of the multiaccess data connection from the second access network to the third access network;
transmit, to a session management function (SMF), a request to perform the path switch of the multiaccess data connection from the second access network to the third access network; and
deregister the first registration in response to the path switch being complete.

9. The network apparatus of claim 8, wherein the request to perform the path switch of the multiaccess data connection from the second access network to the third access network comprises request to update a session management context, the request to update a session management context comprising a non-3GPP path switch indication.

10. The network apparatus of claim 8, wherein the at least one processor is configured to cause the AMF to initiate a timer in response to receiving the second registration request message that indicates the path switch of the multiaccess data connection, wherein the AMF maintains both the first registration and the second registration until the path switch is complete or the timer expires.

11. The network apparatus of claim 10, wherein the at least one processor is configured to cause the AMF to stop the timer in response to receiving a notification that the path switch is complete.

12. The network apparatus of claim 8, wherein the at least one processor is further configured to receive, from the SMF, a notification that the path switch is complete, wherein deregistering the first registration occurs after receiving the notification.

13. The network apparatus of claim 8, wherein the first registration request message has a registration type set to an initial registration type, and wherein the second registration request message has a registration type set to a path switch registration type.

14. The network apparatus of claim 13, wherein the at least one processor is further configured to cause the AMF to transmit a first registration response message to the UE, the first registration response message indicating that the AMF supports the path switch registration type.

15. The network apparatus of claim 8, wherein the second access network is an untrusted non-3GPP access network and wherein the third access network is a trusted non-3GPP access network.

16. The processor of claim 7, wherein the first registration request message has a registration type set to an initial registration type, and wherein the second registration request message has a registration type set to a path switch registration type.

17. The processor of claim 16, wherein the at least one controller is further configured to cause the processor to receive a first registration response message from the access management function, the first registration response message indicating that the access management function supports the path switch registration type.

18. The processor of claim 7, wherein, to switch the traffic of the multiaccess data connection, the at least one controller is configured to cause the processor to transmit a request to establish a data connection via the third access network.

19. The processor of claim 18, wherein the request to establish the data connection via the third access network comprises a non-3GPP path switch indication.

20. The processor of claim 7, wherein the second access network is an untrusted non-3GPP access network and wherein the third access network is a trusted non-3GPP access network.
